(19) United States
(12) Patent Application Publication
(10) Pub. No.: US 2026/0288794 A1
(43) Pub. Date: Sep. 24, 2026

(54) A SYSTEM FOR MULTI MODAL AGGREGATION IN A GOVERNANCE PLATFORM AND A METHOD THEREOF

(71) Applicant: PRIVASAPIEN TECHNOLOGIES PRIVATE LIMITED, Bengaluru (IN)

(72) Inventor: Abilash Soundararajan, Bangalore (IN)

(21) Appl. No.: 19/473,563

(22) PCT Filed: Apr. 8, 2024
(86) PCT No.: PCT/IB2024/053431

§ 371 Date: Oct. 8, 2025

(30) Foreign Application Priority Data
Apr. 10, 2023 (IN) 202341026568

(51) Int. Cl. G06F 16/3329; G06F 16/35; G06F 40/30; H04L 9/40

(52) U.S. Cl. CPC G06F 16/33295; G06F 16/35; G06F 40/30; H04L 63/1433; H04L 63/1466

(57) ABSTRACT

A system 100 for multi modal aggregation and governance platform is provided. The system includes an identity protection module 114 providing a plurality of identities of a user at a plurality of downstream modules, convert them into a unified user identity and proxy the unified identity, a query receiving module 116 receives a plurality of queries from the user and classify them into one or more categories, a governance module 118 understands a context of the multimodal queries, control user prompt or chain of thought prompts, execute the multimodal queries via a responsible artificial intelligence model 120, control the queries or prompts, generate reports related to the risks involved in the input query and the response outputs, query and response distribution module 122 distributes executed the plurality of multimodal queries to the plurality of downstream generative AI modules 140, including translation and select a foremost response.

### EARLIEST PRIORITY DATE

This Application claims priority from a provisional patent application filed in India having Patent Application No. 202341026568, filed on Apr. 10, 2023, and titled “SYSTEM AND METHOD FOR MULTI MODAL GENERATIVE AI AGGREGATION AND GOVERNANCE PLATFORM” and PCT application filed having Patent Application No. PCT/IB2024/053431, filed on Apr. 8, 2024, and titled “A SYSTEM FOR MULTI MODAL AGGREGATION IN A GOVERNANCE PLATFORM AND A METHOD THEREOF”.

### FIELD OF INVENTION

Embodiments of a present disclosure relate to artificial intelligence governance platform and more particularly to a system for multi modal aggregation and governance platform and a method thereof.

### BACKGROUND

A data aggregation and governance platform, is a technology solution designed to collect, organize, manage, and govern data from various sources within an organization. Data organization is the practice of categorizing and classifying data to make it more usable. The data aggregation and governance platforms play a critical role in helping organizations harness the full value of their data assets while ensuring data integrity, security, and compliance with regulatory requirements.

Currently, a user experiences fragmented data across platforms and lack of artificial intelligence (AI) governance framework for compliance and protection. This happens due to different generative AI platforms which are meant for different kinds of settings such as separate settings for text, pictorial, audio and video responses. Current systems do not provide an aggregated AI platform for providing a single interface for multi modal generative AI experience. Also, currently available system lacks in providing AI governance for improving customer experience along with regulatory compliance.

Hence, there is a need for a system for multi modal aggregation in a governance platform and a method thereof which addresses the aforementioned issues.

### OBJECTIVE OF THE INVENTION

An objective of the present invention is to provide a system for multi modal aggregation in a governance platform in a responsible artificial intelligence.

Another objective of the present invention is to test and characterize the resilience of a variety of multimodal data against evasion, poisoning, and privacy attacks.

Yet, an objective of present invention is to provide an aggregated generative AI platform which provides a single interface for multi modal generative AI experience along.

Further, an objective of the present invention is to provide an aggregated platform with artificial intelligence governance for improving customer experience along with regulatory compliance.

### BRIEF DESCRIPTION

In accordance with one embodiment of the disclosure, a system for multi modal aggregation in a governance platform in a responsible artificial intelligence is provided. The system includes at least one processor in communication with a client processor and at least one memory includes a set of program instructions in the form of a processing subsystem is configured to be executed by the at least one processor. The processing subsystem is hosted on a server and configured to execute on a network to control bidirectional communications among a plurality of modules. The plurality of modules includes an identity protection module, a query receiving module, a governance module, and a query and response distribution module. The identity protection module is configured to provide a plurality of identities of a user at a plurality of downstream generative AI modules. The identity protection module is also configured to convert the plurality of user identities into a unified user identity at a user side. Further, the identity protection module is configured to protect the unified user identity of the user by proxying the unified identity. The query receiving module is operatively coupled to the identity protection module wherein the query receiving module is configured to receive a plurality of queries from the user with the unified identity and classify the plurality of queries into one or more categories for providing a response output. The received plurality of queries are multimodal queries. The governance module is operatively coupled to the query receiving module. The governance module is configured to understand a context of the multimodal queries based on a user requirement for preventing or allowing input of the multimodal query based on risk involved in the response outputs via a context-based query control. The governance module is also configured to control user prompt or chain of thought prompts based on whitelisting or backlisting of domains or types of queries for different categories of users against identified type of prompt and the level of risks identified in those prompts, wherein the user prompt is controlled with context-based prompt control. Further, the governance module is configured to execute the multimodal queries via a responsible artificial intelligence model and decide a technology for execution of an application based on the context of multimodal queries. Furthermore, the governance module is configured to control the queries or prompts in such a way that in case of identification of adversarial attack or inappropriate behaviour detection, the user can be prevented from participation on the platform based on configurable pre-defined thresholds. Moreover, the governance module is configured to generate reports related to the risks involved in the input query and the response outputs. The query and response distribution module operatively coupled to the governance module. The query and response distribution module is configured to distribute executed the plurality of multimodal queries to the plurality of downstream generative AI modules downstream generative AI modules for receiving a plurality of responses from the plurality of downstream generative AI modules. The query and response distribution module is also configured to select a foremost response from the plurality of responses and the foremost response to the user.

In accordance with another embodiment a method for operating the system for multi modal aggregation in a governance platform in a responsible artificial intelligence is provided. The method includes providing, by an identification module of a processing subsystem, a plurality of identities of a user at a plurality of downstream generative AI modules. The method also includes converting, by the identification module of the processing subsystem, the plurality of user identities into a unified user identity at a user side. Further, the method includes protecting, by the identification module of the processing subsystem, the unified user identity of the user by proxying the unified identity. Furthermore, the method includes receiving, by a query receiving module of the processing subsystem, a plurality of queries from the user with the unified identity and classify the plurality of queries into one or more categories for providing a response output, wherein received the plurality of queries are multimodal queries. Furthermore, the method includes understanding, by a governance module of the processing subsystem, a context of the multimodal queries based on a user requirement for preventing or allowing input of the multimodal query based on risk involved in the response outputs via a context-based query control. Furthermore, the method includes executing, by a governance module of the processing subsystem, the multimodal queries via a responsible artificial intelligence model and decide a technology for execution of an application based on the context of multimodal queries. Furthermore, the method includes controlling, by the governance module of the processing subsystem, a user prompt or chain of thought prompts based on whitelisting or backlisting of domains or types of queries for different categories of users against identified type of prompt and the level of risks identified in those prompts, wherein the user prompt is controlled with context-based prompt control. Furthermore, the method includes executing, by the governance module of the processing subsystem, the multimodal queries via a responsible artificial intelligence model and decide a technology for execution of an application based on the context of multimodal queries. Furthermore, the method includes controlling, by the governance module of the processing subsystem, the queries or prompts in such a way that in case of identification of adversarial attack or inappropriate behaviour detection, the user can be prevented from participation on the platform based on configurable pre-defined thresholds. Furthermore, the method includes generating reports related to the risks involved in the input query and the response outputs. moreover, the method includes distributing, by a query and response distribution module of the processing subsystem, executed the plurality of multimodal queries to the plurality of downstream generative AI modules for receiving a plurality of responses from the plurality of downstream generative AI modules. Moreover, the method includes selecting, by the query and response distribution module of the processing subsystem, a foremost response from the plurality of responses and the foremost response to the user.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representing a system for multi modal aggregation in a governance platform in a responsible artificial intelligence in accordance with an embodiment of the present disclosure;

FIG. 2 is a block diagram representing an exemplary embodiment of the system for multi modal aggregation in a governance platform in a responsible artificial intelligence of FIG. 1 in accordance with an embodiment of the present disclosure;

FIG. 3 is a block diagram of a computer or a server for the computer-implemented system for multi modal aggregation and governance platform in a responsible artificial intelligence in accordance with an embodiment of the present disclosure;

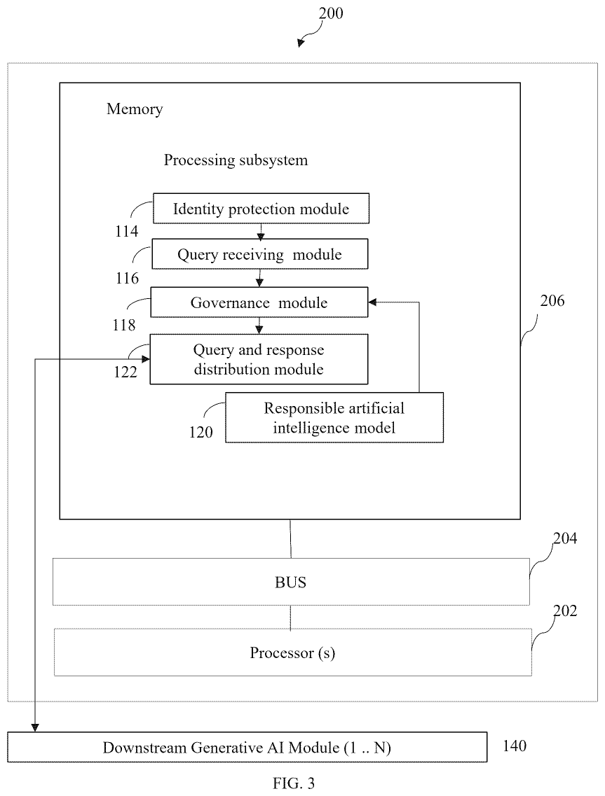

FIG. 4a is a flowchart representing steps involved in a method for operating a computer-implemented system for multi modal aggregation in a governance platform in a responsible artificial intelligence in accordance with an embodiment of the present disclosure; and

FIG. 4b illustrates continued steps involved in a method for operating a computer-implemented system for multi modal aggregation in a governance platform in a responsible artificial intelligence of FIG. 4a in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for multi modal aggregation in a governance platform in a responsible artificial intelligence. The system includes at least one processor in communication with a client processor and at least one memory includes a set of program instructions in the form of a processing subsystem is configured to be executed by the at least one processor. The processing subsystem is hosted on a server and configured to execute on a network to control bidirectional communications among a plurality of modules. The plurality of modules includes an identity protection module, a query receiving module, a governance module, and a query and response distribution module. The identity protection module is configured to provide a plurality of identities of a user at a plurality of downstream generative AI modules. The identity protection module is also configured to convert the plurality of user identities into a unified user identity at a user side. Further, the identity protection module is configured to protect the unified user identity of the user by proxying the unified identity. The query receiving module operatively coupled to the identity protection module wherein the query receiving module is configured to receive a plurality of queries from the user with the unified identity and classify the plurality of queries into one or more categories for providing a response output. The received plurality of queries are multimodal queries. The governance module is operatively coupled to the query receiving module. The governance module is configured to understand a context of the multimodal queries based on a user requirement for preventing or allowing input of the multimodal query based on risk involved in the response outputs via a context-based query control. The governance module is also configured to control user prompt or chain of thought prompts based on whitelisting or backlisting of domains or types of queries for different categories of users against identified type of prompt and the level of risks identified in those prompts, wherein the user prompt is controlled with context-based prompt control. Further, the governance module is configured to execute the multimodal queries via a responsible artificial intelligence model and decide a technology for execution of an application based on the context of multimodal queries. Furthermore, the governance module is configured to control the queries or prompts in such a way that in case of identification of adversarial attack or inappropriate behaviour detection, the user can be prevented from participation on the platform based on configurable pre-defined thresholds. Furthermore, the governance module is configured to generate reports related to the risks involved in the input query and the response outputs. The query and response distribution module operatively coupled to the governance module. The query and response distribution module is configured to distribute executed the plurality of multimodal queries to the plurality of downstream generative AI modules for receiving a plurality of responses from the plurality of downstream generative AI modules. The query and response distribution module is also configured to select a foremost response from the plurality of responses and the foremost response to the user.

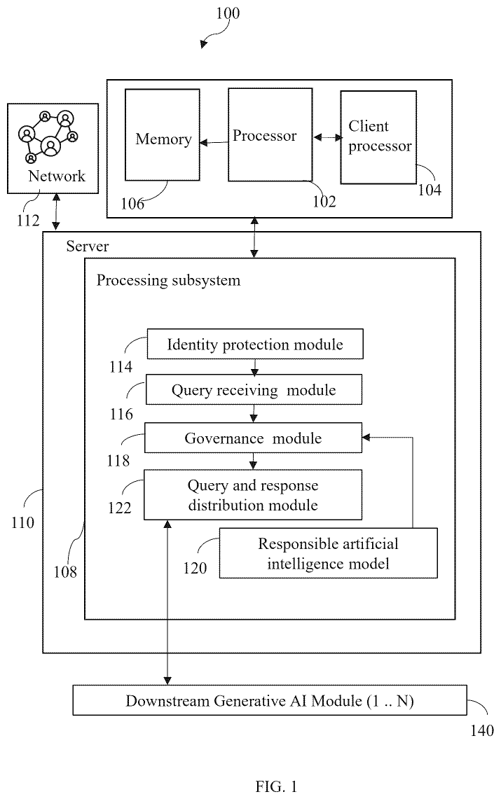

FIG. 1 is a block diagram representing a system for multi modal aggregation in a governance platform in a responsible artificial intelligence in accordance with an embodiment of the present disclosure. In one embodiment, the responsible generative artificial intelligence (AI) refers to the ethical development, deployment, and use of AI systems. Particularly the AI systems generate content autonomously, such as text, images, or music. The potential impact of generative AI on various aspects of an organization, including misinformation, privacy, and the like.

The computer-implemented system 100 includes at least one processor 102 and a memory 106. The at least one processor 102 is in communication with a client processor 104. The processor 102 generally refers to a computational unit or central processing unit (CPU) responsible for executing instructions in a computer system. The phrase “in communication with a client processor” implies that there is a relationship or interaction between at least one processor and a specific type of processor referred to as a “client processor.” Here, the term “client processor” refer to a processor that initiates requests or tasks and interacts with another processor (which may be a server processor) to fulfil those requests.

The memory 106 includes a set of instructions in the form of a processing subsystem 108, configured to be executed by the at least one processor 102. The processing subsystem 108 is hosted on a server 110 and configured to execute on a network 112 to control bidirectional communications among a plurality of modules. In one embodiment, the server 110 may include a cloud server. In another embodiment, the server 110 may include a local server. In one embodiment, the network 112 may include a wired network such as a local area network (LAN). In another embodiment, the network may include a wireless network such as Wi-Fi, Bluetooth, Zigbee, near-field communication (NFC), infrared communication (RFID), or the like.

The plurality of modules includes an identity protection module 114, a query receiving module 116, a governance module 118, and a query and response distribution module 122. In one embodiment, the responsible generative artificial intelligence (AI) refers to the ethical development, deployment, and use of AI systems. Particularly the AI systems generate content autonomously, such as text, images, or music. The potential impact of generative AI on various aspects of an organization, including misinformation, privacy, and the like.

The identity protection module 114 is configured to provide a plurality of identities of a user to a plurality of downstream modules. In one embodiment, the user identity may include username, electronic mail (e-mail) address, and the like. The identity protection module 114 is also configured to convert the plurality of identities into a unified user identity at a user side. Further, the identity protection module 114 is configured to protect the unified user identity of the user by proxying the unified identity. In one embodiment, the unified user identity refers to a concept of consolidating and managing multiple attributes or pieces of information associated with an individual or entity to create a single, comprehensive identity profile. This identity profile typically includes various identifiers, such as name, contact information, demographic data, account credentials, and behavioural patterns, among others. The goal of unified user identity is to establish a cohesive view of an individual or entity across a plurality of systems, platforms, and the like.

The query receiving module 116 is operatively coupled to the identity protection module 114. The query receiving module 116 is configured to receive a plurality of queries from the user with the unified identity and subsequently classify the plurality of queries into one or more categories for providing a response output. In one embodiment, the response output refers to a result or an information produced in response to a query or a request, The received plurality of queries are multimodal queries. In one embodiment, the multimodal query refers to a request made by a user that incorporates multiple modes of input or interaction. Instead of relying solely on text-based queries, multimodal queries allow users to express their intent using a combination of different input modalities, such as text, voice, images, gestures, or even facial expressions. The goal of multimodal queries is to enhance user experience and enable more natural and intuitive interactions with computers and information systems. In one embodiment, the one or more categories includes at least one of an image, a text file, an audio file, and a video file. In one embodiment, the plurality of text files includes plain text (.txt), comma-separated values (.csv), JSON (JavaScript Object Notation) files, XML (extensible Markup Language) files, rich text format (.rtf), HTML (Hypertext Markup Language) files, log files, and the like.

The governance module 118 is operatively coupled to the query receiving module 116. The governance module 118 is configured to understand a context of the multimodal queries based on a user requirement for preventing or allowing input of the multimodal query based on a risk involved in the response output via a context-based query control. In one embodiment, the context-based query control refers to the process of adjusting or filtering search a plurality of queries based on contextual information such as user preferences, location, device type, and other situational factors. By analysing the context in which a search query is made, search engines or information retrieval systems may tailor search results to better meet the user's needs and preferences.

The governance module 118 is also configured to control user prompt or chain of thought (CoT) prompts based on whitelisting or backlisting of domains or types of queries for different categories of users against identified type of prompt and the level of risks identified in those prompts. In one embodiment, the chain-of-thought (CoT) prompting enables complex reasoning capabilities through intermediate reasoning steps. The chain of thought prompt may be combined with few-shot prompting to get better results on more complex tasks that require reasoning before responding. The user prompt is controlled with context-based prompt control. Further, the governance module 118 is configured to execute the multimodal queries via a responsible artificial intelligence model 120 and decide a technology for execution of an application based on the context of multimodal queries.

Furthermore, the governance module 118 is configured to control the queries or prompts in such a way that in case of identification of adversarial attack or inappropriate behaviour detection, the user can be prevented from participation on the platform based on configurable pre-defined thresholds. Moreover, the governance module 118 is configured to generate reports related to the risks involved in the input query and the response outputs. In one embodiment, the responsible AI report focuses on identifying, addressing, and managing risks associated with adversarial machine learning.

The query and response distribution module 122 is operatively coupled to the governance module 118. The query and response distribution module 122 is configured to distribute and execute the plurality of multimodal queries to the plurality of downstream generative AI modules 140 for receiving a plurality of responses from the plurality of downstream generative AI modules. In one embodiment, the plurality of downstream generative AI modules 140 refers to subsequent steps or components in the generation process of prompts that rely on outputs or features from earlier stages. The query and response distribution module 122 is also configured to select a foremost response from the plurality of responses and the foremost response to be selected by the user.

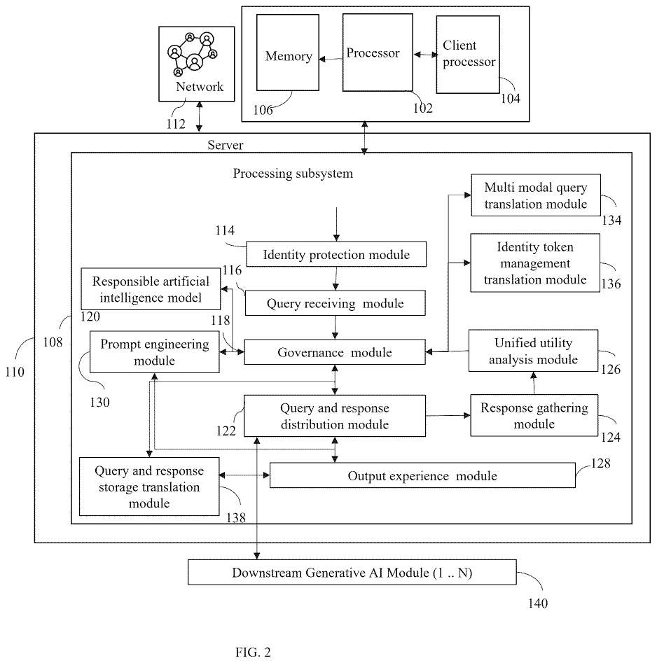

FIG. 2. the processing subsystem 108 comprises a response gathering module 124 operatively coupled to the query and response distribution module 122, wherein the response gathering module 124 is configured to collect the response outputs of the downstream generative AI modules 140 from the query and response distribution module 122. In another embodiment, the processing subsystem 108 includes a unified utility analysis module 126 operatively coupled to response gathering module 124. The unified utility analysis module 126 is configured to collect the response outputs of the downstream generative AI modules 140 and select the most relevant response output. Yet, in one embodiment, the processing subsystem 108 includes an output experience module 128 is operatively coupled to the response gathering module 124. The output experience module 128 is configured to collect a feedback related to the output response from the user and send the feedback to a reinforcement learning from human feedback technique. Further, in one embodiment, the processing subsystem 108 includes a prompt engineering module 130 is operatively coupled to the governance module 118. The prompt engineering module 130 is configured to modify the prompt based on the responsible generative artificial intelligence model 120 to generate the output based on the query received from a user 132.

Furthermore, in one embodiment, the processing subsystem 108 includes a multi modal query translation module 134 is operatively coupled to the governance module 118. The multimodal query translation module 134 is configured to translate the query based on user requirement. Moreover, the processing subsystem 108 includes an identity token management translation module 136 is operatively coupled to the governance module 118. The identity token management translation module 136 is configured to assign an identity to the user 132 and the downstream generative AI modules 140 and protect the identity by managing a plurality of tokens. Moreover, the processing subsystem 108 includes a query and response storage translation module 138 is operatively coupled to the governance module 118 and output experience module 128. The query and response storage translation module 138 is configured capture and store the query responses for governance and audit purposes.

Consider a scenario, where a user X registers with the computer-implemented system 100 by logging into the system. The user X uses e-mail address, a username and a phone number of the user to log in. The identity protection module 114 identifies the user identities an provide the user identities of the user X at a plurality of for keeping the user identity safe. At the same time the identity protection module 114 converts the user identities into a unified user identity at a user side which make the user to manage the user identity. The identity protection module 114 then protects the unified user identity of the user X by proxying the unified identity. The proxying of the user identity may involve the use of an intermediary or proxy server to represent the user's identity when accessing the system. The user X enters a query “Vegetarian hotels near my friend George's house and also close to cancer hospital we are visiting” which is sent to the query receiving module 116. If the query is not matching to the language readable by the digital device, the query translator module translate the query language. The query receiving module 116 receives the query from the user X with the user's unified identity and classify the query into one or more categories for providing a response output. The user X can also send an image of the “hospital” as a query. The governance module 118 understands a context of query based on a user requirement for preventing or allowing input of the multimodal query based on a risk involved in the response output via a context-based query control. In this case, the user wants “Vegetarian hotel” the governance module understands the need of the user X based on factors such as of time of the query, so that the repose output “name and location of the hotel” is correctly displayed. The risks that may be involved are that one or more external entities like gen AI service providers may get to know that George is X's friend, they are going to a cancer hospital, their food preferences, along with date and time. The governance module 118 controls user prompt or chain of thought prompts based on whitelisting or backlisting of the hotels which may not be suitable to the user X. The responsible artificial intelligence model 120 executes the query and decide which application is suitable for the user for finding the hotel. The governance module 118 controls the prompt of users such as if the user is providing his/her phone number or his/her location or friend's location, then the governance module 118 may prevent the user from the risk of misuse of his/her data. The query and response distribution module distributes executed the query to the downstream generative AI modules 140 such a multiple application which provide food services and receives responses from them. The computer-implemented system selects a foremost responses such as a “list of vegetarian hotels close to cancer hospital” removing friend's name and the fact that they may be visiting a cancer hospital and send to the user X along with the risk and option for it to be prevented from being exposed. The user X is allowed to provide feedback of related to his/her experience. The output experience module 128 collects the feedback from the user X and send the feedback to a reinforcement learning from human feedback technique. If the collected user feedback is negative, the prompt engineering module 130 modifies the prompt based on the responsible generative artificial intelligence model 120 to generate the output based on the query received from the user X.

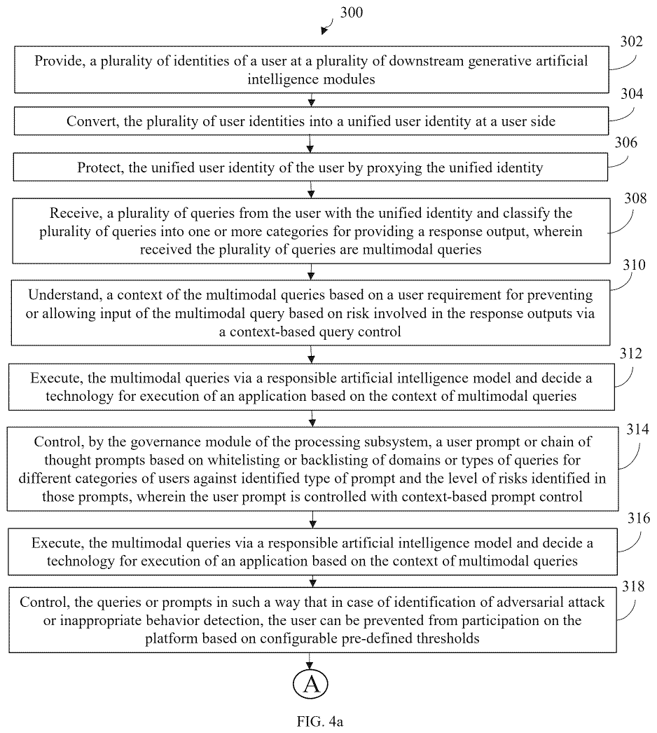

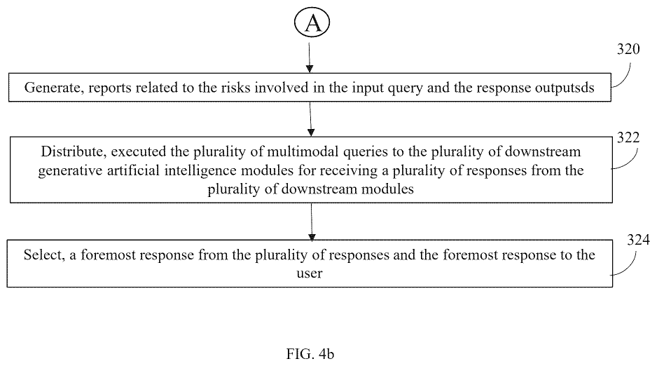

FIG. 4 is a block diagram 200 of a computer or a server for the computer-implemented for multi modal aggregation and governance platform in a responsible artificial intelligence in accordance with an embodiment of the present disclosure. The server includes a processor(s) 202, and memory 202 is operatively coupled to the bus 204.

The processor(s) 204 as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The bus 204 as used herein refers to be internal memory channels or computer network that is used to connect computer components and transfer data between them. The bus 804 includes a serial bus or a parallel bus, wherein the serial bus transmits data in a bit-serial format and the parallel bus transmits data across multiple wires. The bus 204 as used herein, may include but not limited to, a system bus, an internal bus, an external bus, an expansion bus, a frontside bus, a backside bus, and the like.

The memory 206 includes a plurality of subsystems and a plurality of modules stored in the form of an executable program which instructs the processor to the computer-implemented system illustrated in FIG. 1. The memory 206 is substantially similar for the system for multi modal aggregation and governance platform in a responsible artificial intelligence of FIG. 1. The memory 206 has submodules: an identity protection module 114, a query receiving module 116, a governance module 118, and a query and response distribution module 122.

The identity protection module 114 is configured to provide a plurality of identities of a user at a plurality of downstream modules. The identity protection module 114 is also configured to convert the plurality of user identities into a unified user identity at a user side. Further, the identity protection module 114 is configured to protect the unified user identity of the user by proxying the unified identity. In one embodiment, the proxying of unified identity refers to a practice of utilizing an intermediary or proxy service to manage and mediate access to unified identity information. In one embodiment, the present system where unified identity profiles are maintained across multiple platforms or databases, a proxy service acts as an intermediary layer. The intermediary layer facilitates secure and controlled access to identity-related data.

The query receiving module 116 is operatively coupled to the identity protection module 114. The query receiving module 116 is configured to receive a plurality of queries from the user with the unified identity and classify the plurality of queries into one or more categories for providing a response output. The received plurality of queries are multimodal queries.

The governance module 118 is operatively coupled to the query receiving module 116. The governance module 118 is configured to understand a context of the multimodal queries based on a user requirement for preventing or allowing input of the multimodal query based on a risk involved in the response output via a context-based query control. The governance module 118 is also configured to control user prompt or chain of thought prompts based on whitelisting or backlisting of domains or types of queries for different categories of users against identified type of prompt and the level of risks identified in those prompts. The user prompt is controlled with context-based prompt control. Further, the governance module 118 is configured to execute the multimodal queries via a responsible artificial intelligence model 120 and decide a technology for execution of an application based on the context of multimodal queries. Furthermore, the governance module 118 is configured to control the queries or prompts in such a way that in case of identification of adversarial attack or inappropriate behaviour detection, the user can be prevented from participation on the platform based on configurable pre-defined thresholds. Moreover, the governance module 118 is configured to generate reports related to the risks involved in the input query and the response outputs.

The query and response distribution module 122 is operatively coupled to the governance module 118. The query and response distribution module 122 is configured to distribute and execute the plurality of multimodal queries to the plurality of downstream generative AI modules for receiving a plurality of responses from the plurality of downstream generative AI modules. The query and response distribution module 122 is also configured to select a foremost response from the plurality of responses and the foremost response to the user.

Computer memory elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. An executable program stored on any of the above-mentioned storage media may be executable by the processor(s) 202.

FIG. 4a is a flowchart representing steps involved in a method for operating a computer-implemented system for multi modal aggregation and governance platform in a responsible artificial intelligence in accordance with an embodiment of the present disclosure and FIG. 4b illustrates continued steps involved in a method for operating a computer-implemented system for multi modal aggregation and governance platform in a responsible artificial intelligence of FIG. 4a in accordance with an embodiment of the present disclosure.

The method 300 includes providing, by an identification module of a processing subsystem, a plurality of identities of a user at a plurality of downstream generative AI modules in step 302.

The method 300 also includes converting, by the identification module of the processing subsystem, the plurality of user identities into a unified user identity at a user side in step 304.

Further, the method 300 includes protecting, by the identification module of the processing subsystem, the unified user identity of the user by proxying the unified identity in step 306. Furthermore, the method 300 includes receiving, by a query receiving module of the processing subsystem, a plurality of queries from the user with the unified identity and classify the plurality of queries into one or more categories for providing a response output, wherein received the plurality of queries are multimodal queries in step 308.

In one embodiment, the one or more categories includes at least one of an image, a text, an audio file, and a video file. The method 300 also includes collecting, by a unified utility analysis module, the response outputs and select the most relevant response output. The method 300 also include collect a feedback related to the output response from the user and send the feedback to a reinforcement learning from human feedback technique. The method 300 also includes modifying, by a prompt engineering module, based on the responsible generative artificial intelligence model to generate the output based on the query received from a user.

Furthermore, the method 300 includes understanding, by a governance module of the processing subsystem, a context of the multimodal queries based on a user requirement for preventing or allowing input of the multimodal query based on risk involved in the response outputs via a context-based query control in step 310. The method 300 also includes translating, by a multimodal query translation module, the query based on user requirement.

Furthermore, the method 300 includes executing, by a governance module of the processing subsystem, the multimodal queries via a responsible artificial intelligence model and decide a technology for execution of an application based on the context of multimodal queries in step 312. The method 300 also includes assigning, the identity token management translation module is configured to assign an identity to the user and the downstream generative AI modules and protect the identity by managing a plurality of tokens. The method 300 also includes assigning, by an identity token management module is configured to assign an identity to the user and the downstream generative AI modules and protect the identity by managing a plurality of tokens.

Furthermore, the method 300 includes controlling, by the governance module of the processing subsystem, a user prompt or chain of thought prompts based on whitelisting or backlisting of domains or types of queries for different categories of users against identified type of prompt and the level of risks identified in those prompts, wherein the user prompt is controlled with context-based prompt control in step 314.

Furthermore, the method 300 includes executing, by the governance module of the processing subsystem, the multimodal queries via a responsible artificial intelligence model and decide a technology for execution of an application based on the context of multimodal queries in step 316.

Furthermore, the method 300 includes controlling, by the governance module of the processing subsystem, the queries or prompts in such a way that in case of identification of adversarial attack or inappropriate behaviour detection, the user can be prevented from participation on the platform based on configurable pre-defined thresholds in step 318.

Furthermore, the method 300 includes generating reports related to the risks involved in the input query and the response outputs in step 320. The method 300 includes capturing and storing, by a query and response storage module the query responses for governance purpose.

Furthermore, the method 300 includes distributing, by a query and response distribution module of the processing subsystem, executed the plurality of multimodal queries to the plurality of downstream generative AI modules for receiving a plurality of responses from the plurality of downstream generative AI modules in step 322.

Furthermore, the method 300 includes selecting, by the query and response distribution module of the processing subsystem, a foremost response from the plurality of responses and the foremost response to the user in step 324.

Various embodiments of the present disclosure provides a system for multi modal aggregation and governance platform in a responsible artificial intelligence. The system disclosed in the present disclosure tests and characterizes the resilience of a variety of multimodal data against evasion, and privacy attacks poisoning. The governance module of the system disclosed in the present disclosure provides an aggregated generative AI platform which provides a single interface for multi modal generative AI experience along.

Further, the system disclosed in the present disclosure provides an aggregated platform with artificial intelligence governance for improving customer experience along with regulatory compliance. The identity protection module of the system disclosed in the present disclosure converts the plurality of user identities into a unified user identity at a user side for protecting the unified user identity of the user. The unified identities of the user are protected by proxying the unified identity.

Furthermore, the governance module of the system disclosed in the present disclosure uses a context-based query control for preventing input of the multimodal query based on a risk involved in the response output by understanding a context of the multimodal queries based on a user requirement. A context-based prompt control of the system, controls the user prompt or chain of thought prompts based on whitelisting or backlisting of domains and the level of risks identified in those prompts. The governance module of the system prevents the user from participating on a risk-oriented platform by controlling the prompts in in case of identification of adversarial attack or inappropriate behaviour detection.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for multi modal aggregation in a governance platform in a responsible artificial intelligence:
at least one processor in communication with a client processor; and
at least one memory comprises a set of program instructions in the form of a processing subsystem, configured to be executed by the at least one processor, wherein the processing subsystem is hosted on a server and configured to execute on a network to control bidirectional communications among a plurality of modules comprising:
an identity protection module configured to:
provide a plurality of identities of a user at a plurality of downstream modules;
convert the plurality of user identities into a unified user identity at a user side; and
protect the unified user identity of the user by proxying the unified identity;
a query receiving module operatively coupled to the identity protection module wherein the query receiving module is configured to receive a plurality of queries from the user with the unified identity and classify the plurality of queries into one or more categories for providing a response output, wherein received the plurality of queries are multimodal queries;
a governance module operatively coupled to the query receiving module, wherein the governance module is configured to:
understand a context of the multimodal queries based on a user requirement for preventing or allowing input of the multimodal query based on a risk involved in the response output via a context-based query control;
control user prompt or chain of thought prompts based on whitelisting or backlisting of domains or types of queries for different categories of users against identified type of prompt and the level of risks identified in those prompts, wherein the user prompt is controlled with context-based prompt control;
execute the multimodal queries via a responsible artificial intelligence model and decide a technology for execution of an application based on the context of multimodal queries;
control the queries or prompts in such a way that in case of identification of adversarial attack or inappropriate behaviour detection, the user can be prevented from participation on the platform based on configurable pre-defined thresholds; and
generate reports related to the risks involved in the input query and the response outputs; and
a query and response distribution module operatively coupled to the governance module wherein the query and response distribution module is configured to:
distribute executed the plurality of multimodal queries to the plurality of downstream generative AI modules for receiving a plurality of responses from the plurality of downstream generative AI modules; and
select a foremost response from the plurality of responses and the foremost response to be sent to the user.

2. The system as claimed in claim 1, wherein the one or more categories comprises at least one of an image, a text, an audio file, and a video file.

3. The system as claimed in claim 1, wherein the processing subsystem comprises a response gathering module operatively coupled to the query and response distribution module, wherein the response gathering module is configured to collect the response outputs of the downstream generative AI modules from the query and response distribution module.

4. The system as claimed in claim 3, wherein the processing subsystem comprises a unified utility analysis module operatively coupled to response gathering module, wherein the unified utility analysis module is configured to collect the response outputs of the downstream generative AI modules and select the most relevant response output.

5. The system as claimed in claim 3, wherein the processing subsystem comprises an output experience module operatively coupled to the response gathering module wherein the output experience module is configured to collect a feedback related to the output response from the user and send the feedback to a reinforcement learning from human feedback technique.

6. The system as claimed in claim 5, wherein the processing subsystem comprises a prompt engineering module operatively coupled to the governance module wherein the prompt engineering module is configured to modify the prompt based on the responsible generative artificial intelligence model to generate the output based on the query or feedback received from a user.

7. The system as claimed in claim 1, wherein the processing subsystem comprises a multi modal query translation module operatively coupled to the governance module wherein the multimodal query translation module is configured to translate the query based on user requirement.

8. The system as claimed in claim 1, wherein the processing subsystem comprises an identity token management translation module operatively coupled to the governance module wherein the identity token management translation module is configured to assign an identity to the user and the downstream generative AI modules and protect the identity by managing a plurality of tokens.

9. The system as claimed in claim 1, wherein the processing subsystem (1comprises a query and response storage translation module operatively coupled to the governance module and output experience module wherein the query and response storage translation module is configured capture and store the query responses for governance and audit purpose.

10. A method for operating the system for multi modal aggregation and governance platform in a responsible artificial intelligence comprising:
providing, by an identification module of a processing subsystem, a plurality of identities of a user at a plurality of downstream generative AI modules;
converting, by the identification module of the processing subsystem, the plurality of user identities into a unified user identity at a user side;
protecting, by the identification module of the processing subsystem, the unified user identity of the user by proxying the unified identity;
receiving, by a query receiving module of the processing subsystem, a plurality of queries from the user with the unified identity and classify the plurality of queries into one or more categories for providing a response output, wherein received the plurality of queries are multimodal queries;
understanding, by a governance module of the processing subsystem, a context of the multimodal queries based on a user requirement for preventing or allowing input of the multimodal query based on risk involved in the response outputs via a context-based query control;
executing, by a governance module of the processing subsystem, the multimodal queries via a responsible artificial intelligence model and decide a technology for execution of an application based on the context of multimodal queries;
controlling, by the governance module of the processing subsystem, a user prompt or chain of thought prompts based on whitelisting or backlisting of domains or types of queries for different categories of users against identified type of prompt and the level of risks identified in those prompts, wherein the user prompt is controlled with context-based prompt control;
executing, by the governance module of the processing subsystem, the multimodal queries via a responsible artificial intelligence model and decide a technology for execution of an application based on the context of multimodal queries;
controlling, by the governance module of the processing subsystem, the queries or prompts in such a way that in case of identification of adversarial attack or inappropriate behaviour detection, the user can be prevented from participation on the platform based on configurable pre-defined thresholds;
generating, by the governance module of the processing subsystem, reports related to the risks involved in the input query and the response outputs;
distributing, by a query and response distribution module of the processing subsystem, executed the plurality of multimodal queries to the plurality of downstream generative AI modules for receiving a plurality of responses from the plurality of downstream modules; and
selecting, by the query and response distribution module of the processing subsystem, a foremost response from the plurality of responses and the foremost response to the user.
